(19) United States
(12) Patent Application Publication
(10) Pub. No.: US 2002/0063733 A1
(43) Pub. Date: May 30, 2002

(54) Configurable interactive chart application

(76) Inventors: Uwe Franke, Munchen (DE); Michael Statz, Seefeld (DE)

Correspondence Address: MARSHALL, GERSTEIN & BORUN, 6300 SEARS TOWER, 233 SOUTH WACKER, CHICAGO, IL, 60606-6357, US

(21) Appl. No.: 09/934,430

(22) Filed: Aug. 21, 2001

(30) Foreign Application Priority Data
Aug. 21, 2000 (EP) 00 117 943.1

(51) Int. Cl. G09G 5/00

(52) U.S. Cl. 345/739

(57) ABSTRACT

In a technique for the configurable charting of data such as price shares, the data to be displayed are loaded from a server (2) to a terminal (5) by means of the Internet (1). The displayed data can then be individually configured on the display unit (monitor) (6) of the terminal (5). The user can select the configuration of the display using a pointer control unit (9) by positioning a cursor (11) in the display field (12) of the data itself. In addition, it is possible to install highlighted buttons (13, 13′) in the display field (12) of the data, which when a cursor (11) is activated provide additional information linked to the position of the button (13, 13′). For example, the data can reflect share price histories and the buttons (13, 13′) are provided at those temporal positions of a share price chart where events that could be of importance to the development of the share prices took place. Finally, it is possible to set limits within the display of the data, so that the user is automatically warned as soon as the development of prices falls below or exceeds the limit. Furthermore, the user can send the current display field (12) together with line studies and settings to another user.

### FIELD OF THE INVENTION

The present invention relates to a method for charting (time-related) data, especially share prices, on the display unit of a data network terminal. The present invention also relates to a software program that enables the use of such a method when it is loaded into the memory of an Internet terminal. Finally, the present invention also relates to an Internet web site that enables users of a data network terminal to download a software program of this type.

### BACKGROUND OF THE INVENTION

The general environment of the present invention is the Internet and, to be more precise, the possibilities of using the Internet to enable the client of an online bank, online stockbroker (online share dealer), insurance company, investment company or investment analyst to display share prices and share price histories on his PC. The user can use the graphical, diagram-like display of the share price to prepare an analysis and thus a prognosis of the potential future course of the share price.

This type of service from online banks and online stockbrokers is already widespread. The data representing the course of the share price are loaded onto the user's terminal from a server of the online bank or online broker (or a company authorized by such) via a data network, especially the Internet. There, the data are presented statically, i.e., as long as the user does not download a new process by re-dialing the server's address, the display of the data on the user's screen remains unchanged.

### BRIEF DESCRIPTION OF THE DRAWINGS

The advantages and features of the present invention are presented in more detail in the following descriptions of sample implementations and in reference to the figures in the attached drawings, in which:

FIG. 1 shows a diagram of a system for the implementation of the present invention,

FIG. 2 shows the “dragging” feature in an illustration before (FIG. 2a) and after (FIG. 2b) the process,

FIG. 3 shows the “zoom in” feature,

FIG. 4 shows the “zoom out” feature,

FIG. 5 shows the “highlighted buttons for displaying additional information” feature,

FIG. 6 shows how several data can be displayed in a display field,

FIG. 7 shows the “attach notification” feature,

FIG. 8 shows the “additional information” feature, and

FIG. 9 shows the “movie effect” feature, through which the data are put together bit by bit on the display in a kind of film presentation.

### DETAILED DESCRIPTION OF THE PREFERRED EMBODIMENTS

The task of the present invention is to provide a technique that enables a user such as a client of an online bank or online stockbroker to control individually the presentation of data such as price shares on the screen of his terminal in a simple manner. This task is solved through the characterizing portions of the independent claims in accordance with the present invention. The dependent claims present an even more advantageous implementation of the central concept of the present invention.

A first aspect of the present invention therefore provides a method for the configurable charting of time-related data such as share prices. The data to be displayed are loaded from a server to a terminal by means of a data network such as the Internet. The data are then presented on a display unit of the terminal (for example a PC). Finally, the user can individually configure the display of the data on the display unit of the terminal; the user can control the configuration of the data by using a pointer to select the position of the cursor on the data display field of the display unit itself. The user thus moves the cursor within the display field itself using a device such as a mouse and prompts the configuration of the display there in such a manner as he may require for his chart analyses.

The configuration of the display of the data can be a process selected from the processes of dragging or zooming, or a combination thereof.

The configuration can especially be accomplished in that the user presses an activation button on the pointer (mouse, etc.) to move the cursor within the display field.

One “configuration possibility” that is possible directly on the chart is simply clicking, which activates the display of any detailed information available at that point in time. The user can return to the normal mode by clicking again. Such clicking is not only possible throughout the display field (chart), but also on particular buttons as well. The buttons indicate where additional detailed or especially important information is available.

The display of the data can also be configured via the terminal without interacting with the server. For example, this can be accomplished by loading a software program in the form of so-called applets from the server to the user's terminal, in addition to the data itself. An applet is a small program element, such as the programmed program element in the programming language Java, which can be executed in the Web browser and which generally improves the interactivity of Web functions.

According to another aspect of the present invention, a method is provided for charting data, in which data are loaded from a server to the terminal via a data network and are displayed on the display unit of the terminal. Highlighted buttons are shown on the display field, on which special information is displayed. By activating the buttons using a cursor, further information is displayed that is linked to the position of the buttons within the display field or the position of the buttons in relation to the displayed data. The data can especially provide share price histories, in which case buttons are provided at those temporal positions of a share price history where events that could be of special significance for the development of the share price took place.

By activating the buttons, new information windows can be generated on the display unit and/or a link (referral to another HTML object or web site) can be activated.

In the course of downloading the data to be displayed from the server to the terminal, a software program for individually configuring the display of the data can also be downloaded.

The cursor can be shown as a cross hair cursor on the display field. The cursor can especially be automatically represented as a cross hair cursor as soon as it is moved into the data display field. The cross hairs of the cursor can span the entire data display field.

The structure of the data display can be shown on the display unit bit by bit in a form of film presentation so to speak, according to the temporal history of the development of the data.

An acoustic indicator, whose volume and/or pitch depend on the value of the displayed data in the area of the cursor, can be activated by moving the cursor along the displayed data, especially along a share price line.

In accordance with another aspect of the present invention, a method is provided for charting data, especially share prices, whereby the data are repeatedly loaded from a server to a terminal via a data network, so that the data shown on the display unit of the terminal are updated in the course of the repeated loading. The user can define at least one limit in the data display field by activating a cursor in the display field itself. For example, the terminal automatically triggers an action as soon as the graph representing the data falls below, exceeds or reaches the limit.

Of course, the actions can also be launched on the client end (“terminal”), but the user must also be online to do this. There is however also the possibility of storing the user's settings on the server if desired, and notifying the user from the server end-by E-mail, pager, fax, . . . -regardless of whether or not the user is online.

The action can be an order to purchase or sell shares via an online connection and/or notify the user via an optical, acoustic, etc. alarm.

In accordance with another aspect of the invention, a software program as well as Internet web site, such as that of an online bank or online stockbroker, are provided to enable the user of a terminal to download such a software program.

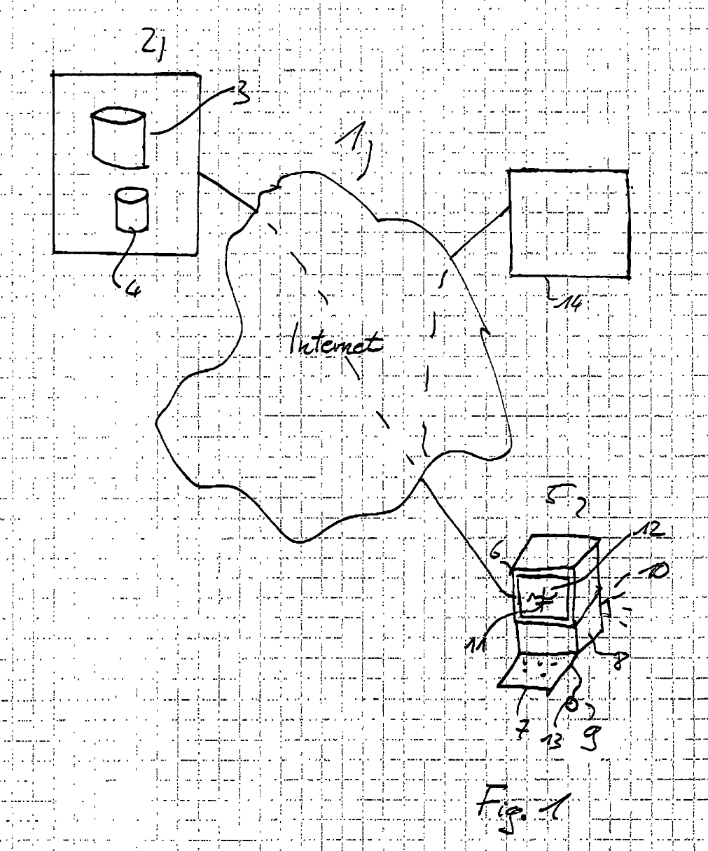

In reference to FIG. 1, a data network transmission system in which the present invention can be accomplished is explained. The central communications network 1 is the Internet. Various participants such as a user with a terminal 5, a server 2 of an online bank, online broker or a company authorized by such, as well as other participants 14, are connected via this communications network 1. The terminal can be a PC 5, which in addition to a keyboard 7 also has a cursor control unit (mouse) 9, a screen 6 with a display field 12, a processor 8 as well as the possibility of emitting acoustic signals (loudspeakers) 10.

The server 2 has a database 3 in which data such as share prices are continually updated. A software program 4 (applet) that can be loaded via the Internet 1 onto the user's terminal 5 is also stored on the server 2.

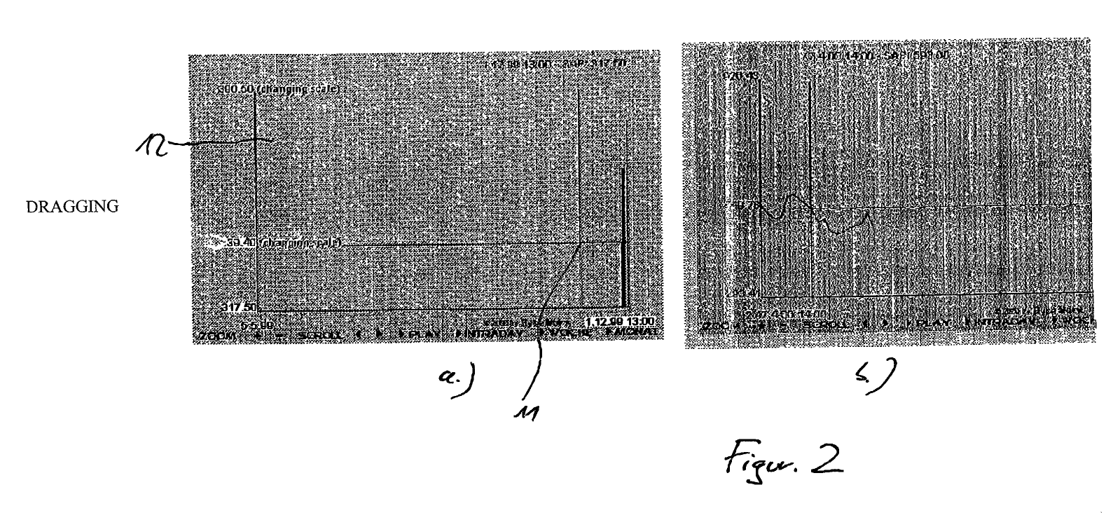

Referring to FIG. 2, the general principle of the present invention is explained below.

If the user of the terminal 5 has dialed the address of the data network server 2, the data to be displayed from the database 3 on the one hand and a software program (applet) 4 on the other hand are loaded from the server 2 onto the terminal 5 via the Internet 1. As soon as this loading process is complete, the online connection is essentially no longer necessary for further use (with the exception of so-called “ticker data” and other current data that must be continuously updated), since the data can be displayed and the software used in the configuration of the data display can be executed by the processor 8 of the terminal 5 without the interaction of the server 2.

In summary, once the downloading process is complete, the user of the terminal 5 has at his disposal a complete set of data for displaying data as well as a software program for configuring the display of the data on the screen 6 of the terminal 5, which can be run on the terminal 5. Of course the data to be displayed can also be continuously updated in a real-time application if an online connection exists. Once the software program is available on the terminal 5, downloading the data a single time usually suffices.

The central component of the configuration of the data display on the display field 12 of the screen (display unit) 6 of the terminal 5 is the activation of the cursor 11 using the cursor control unit (mouse) 9 of the terminal 5. As shown in FIG. 2, the cursor is represented on the display field 12 by a cross hair 11 that essentially spans the entire display field 12 for the data. In particular, the cursor 11 that is shown in the usual form (such as a small pointer) outside the display field, automatically “transforms” into a cross hair cursor 11 as soon as the user moves the cursor into the display field 12 by means of the mouse 9. When the cursor is moved out of the display field 12, the reverse process takes place.

All further processes for configuring the display of the data in the display field 12 can then be accomplished by the user through the activation and, if necessary, moving of the cursor 11 into the display field 12 of the data itself. It is therefore not necessary to use the mouse 9 to move the cursor onto buttons outside of the display field 12 to configure the display of the data 11. Since the configuration of the display of the data is launched and controlled within the display field 12 itself, it is considerably easier for the user to configure the display according to his taste and wishes.

Thus a process for configuring the display of the data in the display field 12 involves first moving the cross hair cursor 11 onto a certain point in the display field 12 and then using the appropriate movement of the mouse to move the cursor into the display field 12 and activating the button 13 on the mouse 9, which among experts is often referred to as “dragging.” The extent of the movement of the cursor 11 in the display field 12 is a parameter for the configuration process.

FIGS. 2a and 2b show the “dragging” feature, by which the cross hair cursor 11 is moved to a certain position in the display field 12 and is then dragged as desired by the user with the mouse button 13 pressed. The direction and extent of the dragging corresponds to the movement of the cursor 11. If as shown it is only possible to move to the right or left, the dragging takes place parallel to the direction of the components of the cursor movement.

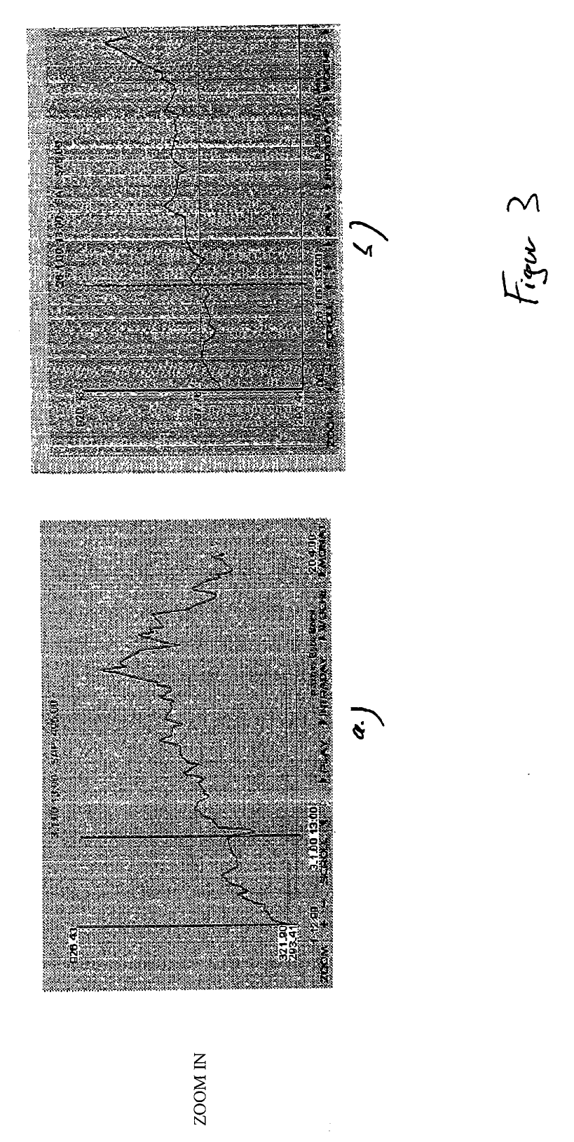

FIG. 3a shows the “zoom in” feature by which the center of the zoom area is first marked by the cross hair and the zoom factor is then set by moving the cross hair cursor 11 while pressing the mouse button 13.

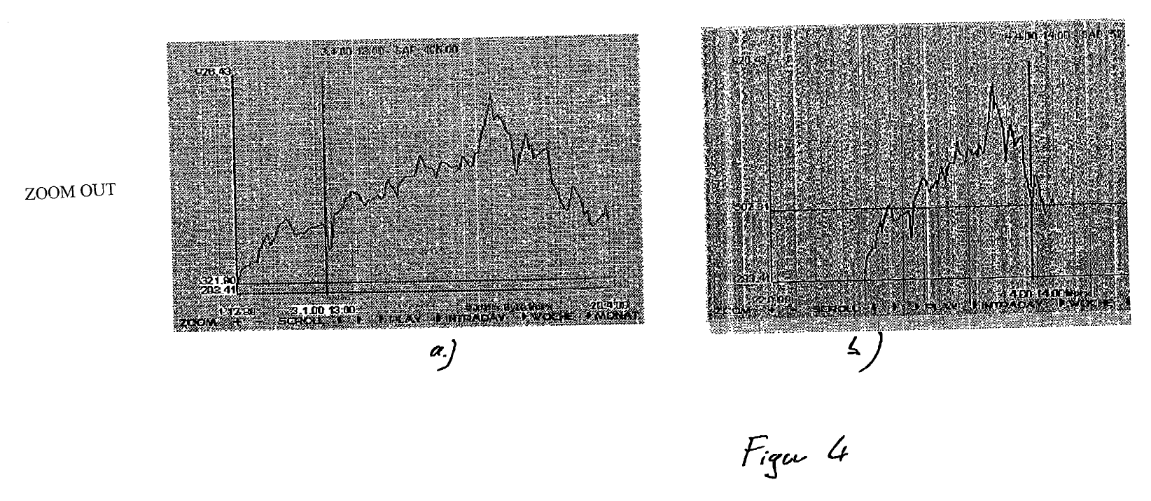

FIG. 4 shows the “zoom out” feature, which is essentially the reverse process of the “zoom in” feature shown in FIG. 3. The common feature of the zoom processes is that the zoom factor is a linear or logarithmic function of the cursor movement, especially the component of the cursor movement parallel to the zoom direction.

Using these “zoom” or “drag” (“scroll”) features, graphs such as share price charts can thus be configured directly according to the user's wishes.

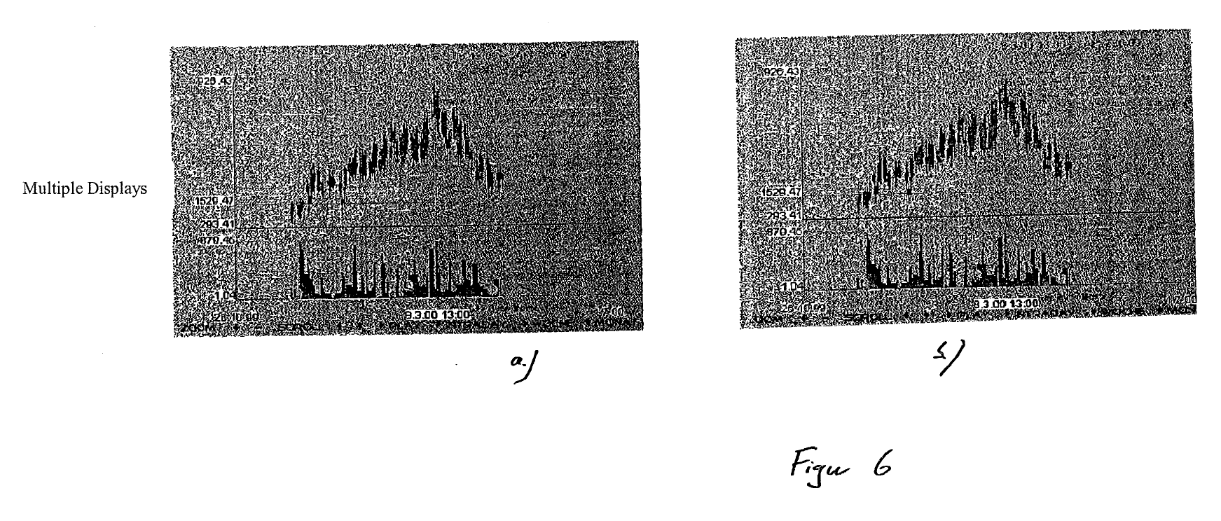

If the chart comprises several curves/axes (as shown for example in FIG. 6, e.g. share price history above, trade volume below), all of the (time) axes and curves belonging to one another respond to the zoom and/or drag of one axis.

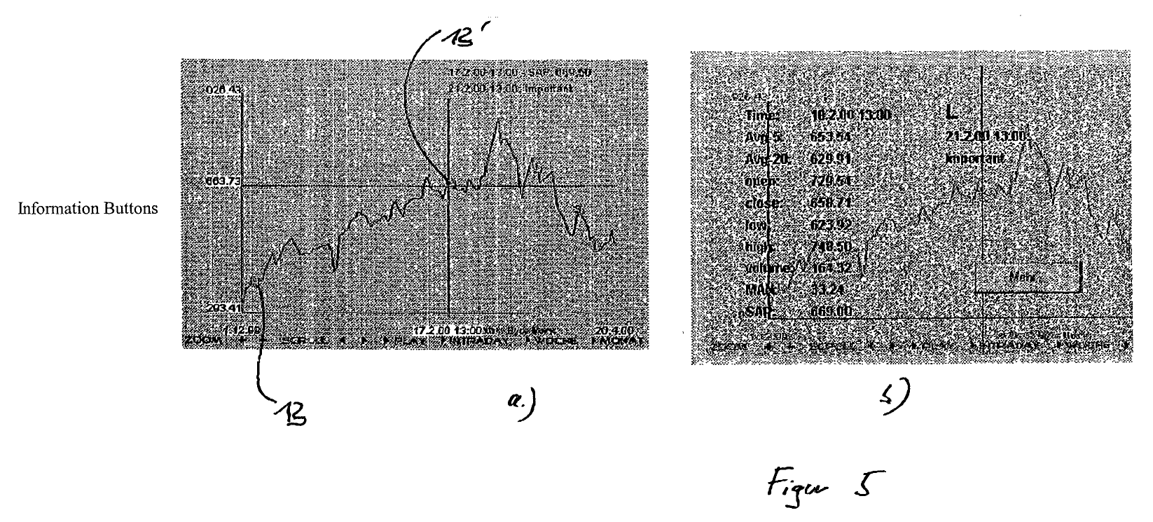

FIG. 5 shows another aspect of the present invention. According to this aspect, highlighted buttons 13, 13′ are provided in the display field 12 of the data. These buttons 13, 13′ can already be installed by the operator of the server 2. Alternatively or additionally, there may also be a possibility for the user himself to install such buttons 13, 13′ in the displayed chart and especially in a share price line. These buttons 13, 13′ can be provided at those points in time in a chronological share price history where events that could be of importance to the development of the share prices took place.

If the cross hair cursor 11 is then moved onto such a button 13, 13′ and the mouse button 13 is activated, additional information is shown, which is linked to the immediate surroundings or the exact position on which the button 13, 13′ is positioned.

As shown in FIG. 5b, this additional information could for example be about the share price history, such as maximum value, turnover and the like. In addition, other windows can be opened by activating the buttons 13, 13′ for information regarding the economic activity, such as profit warnings, share splits or other announcements. If necessary, the button 13, 13′ can be activated by pressing the mouse button 13 to activate a so-called link, i.e., a referral to another file or another address of the data network (Internet) 1. For example, such buttons can be linked to the so-called home page of company whose share price history is being displayed at that time.

The buttons 13, 13′ can therefore provide commentaries to the graph and referral links. Thus, events can be highlighted by a symbol directly in the share price chart, which can be clicked on to show additional commentaries and/or “link” other Internet pages.

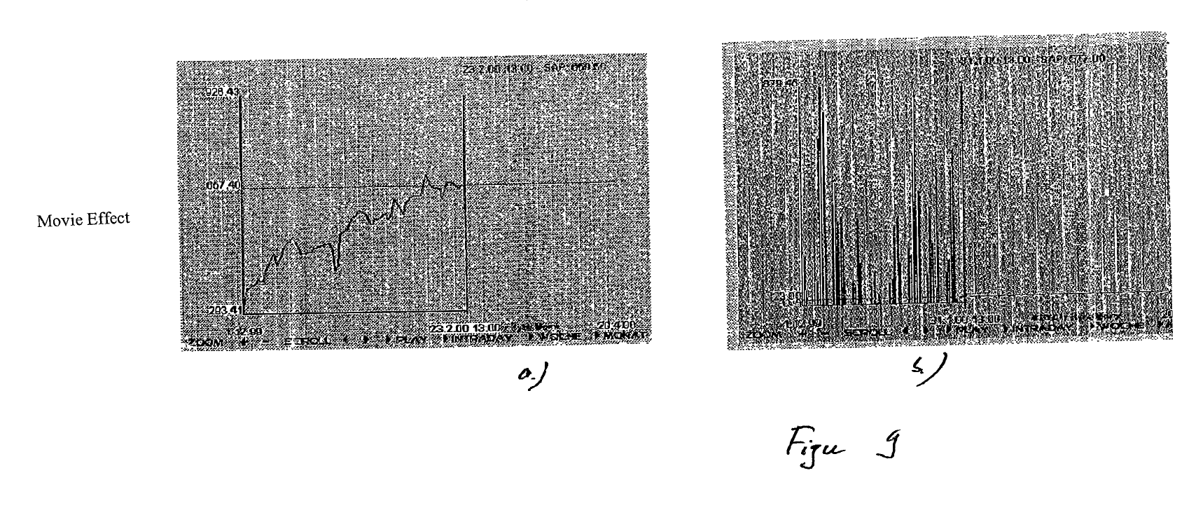

Another configuration possibility that is possible directly in the display field (chart), is simply “clicking” by activating the cursor control unit (such as a mouse button), which activates a detailed display of all the information belonging to that point in time. The result of this function is shown in FIG. 9. By clicking again, the user returns to the normal mode. This clicking is possible not only throughout the chart, but also on special buttons. The buttons show where additional detailed information or especially important commentaries are available.

Another feature of the present invention is that when moving the cross hair cursor 12, 12′ along the displayed data, such as the chart of share prices, an acoustic signal 10 is sounded, whose volume and/or pitch depend on the value of the displayed data in the area of the cursor 11. For example, when the cursor 11 is moved along the chart of share prices, a sound can be played whose pitch and volume correspond to the market value or trade volume and other data potentially relevant to the share price. Pitch and volume thus enable a two-dimensional rendering of acoustic information.

FIGS. 6a and 6b show that different symbols can be selected for the graphs and that multiple displays, for example share price and trade volume, are also possible. As explained above, if the chart comprises several curves/axes, such as share price history above, trade volume below, all of the (time) axes and curves belonging to one another respond to the zoom and/or scroll of one axis.

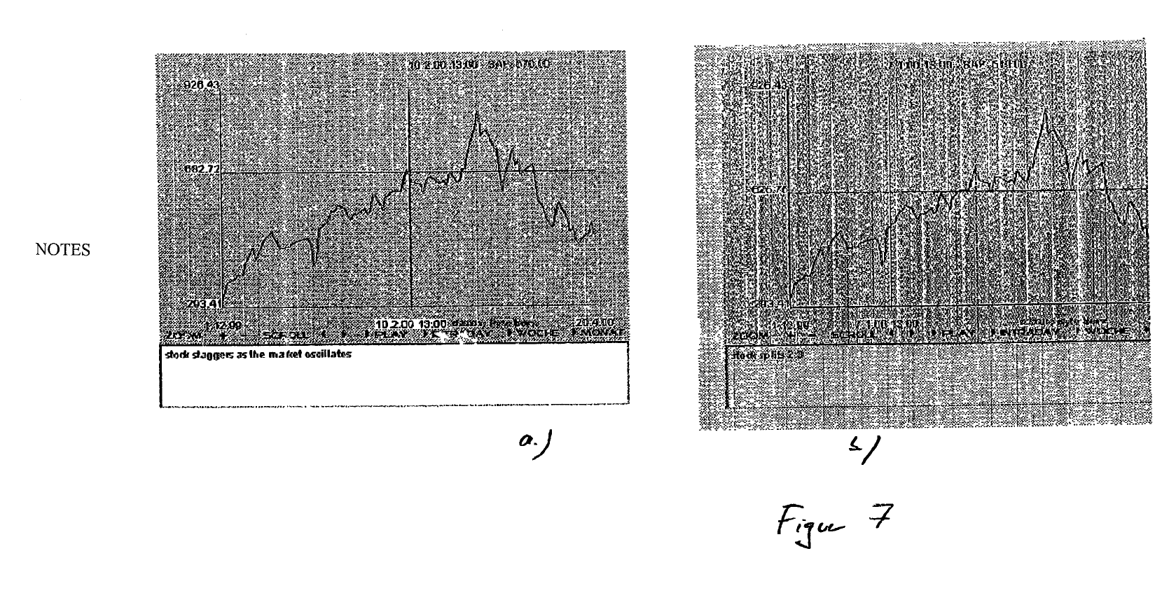

FIGS. 7a and 7b show how notes can be attached for certain points in time in the share price history.

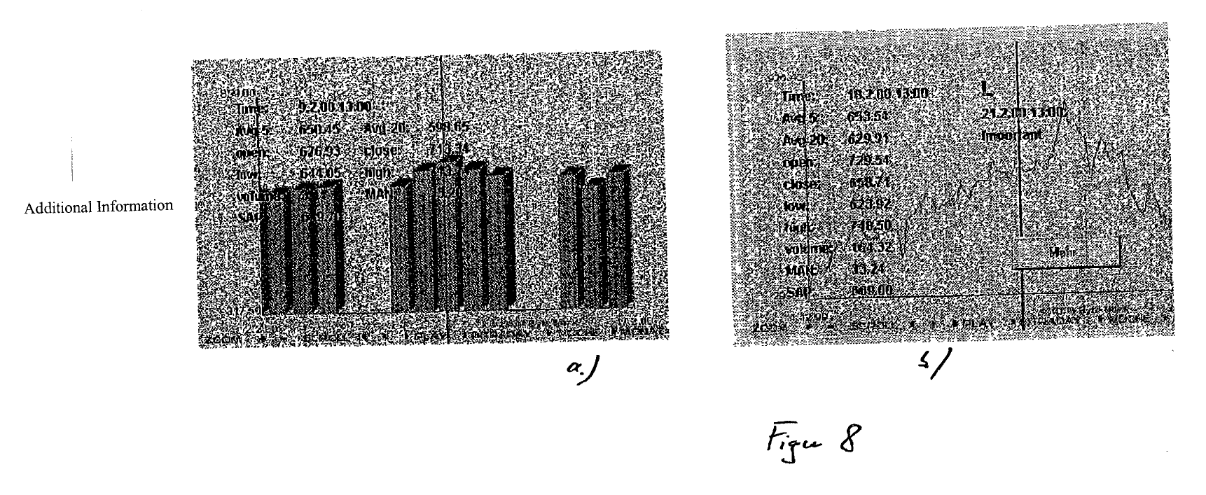

FIGS. 8a and 8b show additional information that can be reflected in the development of share prices.

FIGS. 9a and 9b show that in the present invention, the structure of the data can be shown in the display field 12 of the display unit (monitor) 6 bit by bit in a form of film presentation so to speak, according to the temporal history of the development of the data. The development of share prices is then shown as a “film” so to speak, in which the chart of share prices is assembled in the chronologically correct sequence. This feature can be used together with the acoustic signal 10, i.e., in the course of the chronological presentation of the chart of share prices a sound is played, whose pitch and volume corresponds to the development of share prices.

According to another aspect of the invention, the user himself can define limits (“radar lines”) in the display field 12 of the data by activating the cursor 11 in the display field 12. That is, such radar lines can be drawn into the share price chart by positioning the cross hair cursor 11 on the display field 12 and then moving the cursor position by activating the mouse 9 while pressing the mouse button 13. If for example the development of share prices, i.e., the graph that reflects the development of share prices, now falls short of or exceeds (or reaches) the limit, an action can be launched automatically.

Through the limits in the chart, the user can for example indicate that he wishes to be informed (acoustic, optical, SMS news, telephone call, e-mail, etc.) when the share price goes beyond this limit. If necessary, the user's terminal 5 can automatically trigger the order to buy or sell a certain share if the development of share prices passes a limit. This can be accomplished for example via an online connection to an online stockbroker or online bank.

Of course, the actions can also be launched on the client end (“terminal”), but the user must also be online to do this. There is however also the possibility of storing the user's settings on the server if desired, and notifying the user from the server end-by E-mail, pager, fax, . . . -regardless of whether or not the user is online.

It is also possible to provide so-called “radar indicators.” The user can provide and set parameters for various mathematical functions (“indicators”) based on the share price chart and the trade volume, so that he is notified as soon as a defined value of the radar indicator falls below or exceeds the limit.

Another function is sending possibly configured share price charts to third parties. By selecting this function, all of the changes made to the share price chart by a first user (commentaries, line studies, indicators, . . . ) are stored under a key. This key is embedded in an Internet address (URL) and is sent by E-mail to the address provided by user A. The recipient of this message, user B, can now go to this Internet address and access the share price chart with the changes stored by user A. As a result, the first user can send his chart with his commentaries, line studies, etc. to other Internet users.

The current display field 12 can also be saved on the Internet server as a share price chart and imbedded in this E-mail message. In this case, the specified Internet address (URL) is assigned to the share price chart as a hyper link feature. This imbedding requires that the E-mail be sent in a suitable format such as HTML. If the E-mail is sent in a pure text format, the share price chart can be sent as an attachment to the E-mail.

The present invention thus generally allows the user to configure share price charts or other graphs on the monitor 6 of his terminal 5 in a simple manner or to link such to other information. According to the main concept of the invention, this is essentially accomplished by activating a cursor in the area of the display field 12 of the relevant data itself. For all of the actions mentioned above, it is not necessary for the user to activate buttons outside of the display field. In addition, no interaction with the server of the network 1 (Internet) is necessary for the configuration since the corresponding user program 4 is executed on the terminal 5. Thus, the configuration process is carried out independently of possible restrictions resulting from online connections. The online expenses are also reduced since the configuration process can be carried out offline.

We claim:

1. Method for the configurable charting of time-related data, such as share prices, consisting of the following steps:
loading the data to be displayed from a server (2) to a terminal (5) by means of a data network (1),
displaying the data on a display unit (6) of the terminal (5), and
individually configuring the display of the data on the display unit (6) of the terminal (5), whereby the type of configuration of the display is selected by means of a cursor (11) that is activated in the display field (12) of the data itself.

2. Method according to claim 1, characterized in that the type of the configuration of the display is selected by the position of the cursor (11) in the display field (12).

3. Method according to claim 1 or 2, characterized in that the configuration of the display of the data is a process selected by scrolling, zooming or a combination thereof.

4. Method according to one of the preceding claims, characterized in that the configuration is accomplished in that the user moves the cursor (11) within the display field (12) while pressing the activation button of the pointer control unit (9).

5. Method according to one of the preceding claims, characterized in that the configuration of the display of the data is accomplished via the terminal (5) without interaction with the server (2).

6. Method according to one of the preceding claims, characterized in that activating a mouse button for a cursor positioned within the display field (12) prompts a detailed display of all information belonging to this point in time.

7. Method for charting data such as share prices consisting of the following steps:
loading the data to be displayed from a server (2) to a terminal (5) via a data network (1),
displaying the data on a display unit (6) of the terminal (5), and in which highlighted buttons (13, 13′) are shown in the display field (12) of the data, which provide additional information that is linked to the position of the button (13, 13′) when a cursor (11) is activated.

8. Method according to claim 7, characterized in that the data reflect share price histories and the buttons (13, 13′) are provided at those temporal positions of a share price course at which events that could be of importance to the development of the share price took place.

9. Method according to claim 7 or 8, characterized in that when the buttons (13, 13′) are activated, new information windows are generated on the display unit (6) and/or a link to another address of the data network (1) is activated.

10. Method according to one of the preceding claims, characterized in that a software program is also loaded from the server (2) to the terminal (5) in order to carry out the individual modification of the display of the data.

11. Method according to one of the preceding claims, characterized in that the cursor is displayed in the display field (12) as a cross hair cursor (11).

12. Method according to claim 11, characterized in that the cursor is automatically shown as a cross hair (11) as soon as it is moved into the display field (12).

13. Method according to claim 11 or 12, characterized in that the cross hair (11) span the entire display field (12) of the data.

14. Method according to one of the preceding claims, characterized in that the structure of the data can be shown on the display unit bit by bit (6) according to the temporal history of the development of the data.

15. Method according to one of the preceding claims, characterized in that an acoustic signal (10) whose volume and/or pitch depend on the value of the displayed data in the area of the cursor (11) is sounded when the cursor (11) is moved along the displayed data.

16. Method according to one of the preceding claims, characterized in that all of the configurations carried out by the user can be saved.

17. Method according to claim 16, characterized in that the saved configurations as keys in an Internet address can be sent by E-mail to a data network address together with an embedded share price chart.

18. Method for charting data such as share prices, consisting of the following steps:
repeated loading of the data to be displayed from a server (2) to a terminal (5) via a data network (1),
updated display of the data on a display unit (6) of the terminal (5) in the form of graphs in the course of the repeated loading and
definition of at least one limit in the display field (12) of the data by means of activating a cursor (11) in the display field (12) itself, in which an action is automatically triggered as soon as the graph falls below or exceeds the limit.

19. Method according to claim 18, characterized in that the action is an order to purchase or sell shares via an online connection and/or to notify the user by an alarm.

20. Software program, characterized in that it implements a procedure in accordance with one of the preceding claims in the condition loaded in the memory of the Internet terminal (5).

21. Internet web site, especially an online bank, characterized in that it makes it possible for the user of a terminal (5) to download a software program in accordance with claim 16.
